(19) United States
(12) Patent Application Publication
(10) Pub. No.: US 2011/0293427 A1
(43) Pub. Date: Dec. 1, 2011

(54) ROTOR BLADE CAMBER ADJUSTMENT

(76) Inventor: Michael Alan Beachy Head, Newlands (ZA)

(21) Appl. No.: 13/145,675

(22) PCT Filed: Nov. 19, 2010
(86) PCT No.: PCT/IB10/55303

§ 371 Date: Aug. 18, 2011

(30) Foreign Application Priority Data
Dec. 15, 2009 (GB) 0921893.4

(51) Int. Cl. B64C 27/467

(52) U.S. Cl. 416/148

(57) ABSTRACT

A rotor for a rotary wing aircraft is provided, which includes a hub and a number of rotor blades. Each rotor blade includes an elongate central body that has a leading edge and a flap along the leading edge. The body is pivotally connected to the hub, to pivot about a longitudinal pivot axis, and the flap is pivotally attached to the body. The rotor blade includes a leading camber adjustment mechanism that pivots the flap downwards relative to the body when the body is pivoted in a direction in which its leading edge is lifted. Similarly, the rotor blade has a trailing flap and a trailing camber adjustment mechanism that pivots the trailing flap downwards relative to the body when the body is pivoted in a direction in which its trailing edge is lifted.

### CROSS REFERENCE TO RELATED APPLICATIONS

This application is a United States national phase of co-pending international patent application No. PCT/IB2010/055303, filed Nov. 19, 2010, which claims priority to Great Britain application No. GB0921893.4, filed Dec. 15, 2009, the disclosures of which are incorporated herein by reference.

### FIELD OF THE INVENTION

This invention relates to rotors of rotary wing aircraft. In particular, the invention relates to a rotor that is configured to adjusting rotor blade camber.

### BACKGROUND TO THE INVENTION

Rotors are widely used in rotary wing aircraft (e.g. helicopters) to provide lift and to propel the aircraft in different directions. The use of rotors has also been proposed in arrangements where the rotors are used in the conventional (rotating) way, but are selectively kept stationary relative to the aircraft during flight, so that rotor blades can serve as fixed wings that provide lift. In such a hybrid aircraft, the direction at which air travels relative to rotor blades that are retreating relative to the aircraft (i.e. travelling backwards relative to the aircraft) is reversed when these blades are kept stationary.

A typical helicopter rotor spins in one direction at a constant rotational speed, and thus the aerofoils of rotor blades are oriented so as to generate lift whilst travelling in the direction of rotation. The lift generated by the blades can be adjusted by adjusting the pitch angle of the rotor blades via the helicopter controls and thus changing the angle of attack of the rotor blades.

In a fixed-wing aircraft, the aerofoil generates lift with the leading edge orientated in the direction of forward motion of the aircraft. Variation in lift is achieved primarily by changing the angle of attack of the aircraft (and thus changing the angle of attack of the wings) and its forward velocity. However, flaps also work (to an extent) in changing the shape and/or area of the aerofoil, and thus altering its lift (and drag) generating characteristics.

Aerofoil shapes for helicopter blades are typically designed to provide lift, minimise drag, reduce torsion along the longitudinal axis of the blade, and delay the formation of sonic shocks on the advancing blade as well as the onset of stall, across the varying operational angles of attack. However, any fixed aerofoil shape will necessarily not function optimally across the entire range of angles of attack. Similarly, the aerofoils of fixed wings are designed to operate optimally at their fixed orientation relative to the aircraft. In many modern cases, the physical characteristics of such aerofoils (such as chord length and camber) can be changed in flight with the operation of flaps, to vary the lift (and drag) generated.

The use of an aerofoil to serve the dual purposes of providing lift whilst rotating as a helicopter rotor and providing lift whilst operating as a fixed wing in forward flight causes a problem in that the optimal aerofoil shape and orientation for either circumstance differs. Due to the typical differences in form, arrangement and operation, developing a single set of lifting surfaces which can efficiently convert from spinning rotor to fixed-wing function, and back again (e.g. for use in a hybrid helicopter) is challenging. For example, a typical two-bladed conventional helicopter rotor, if fixed in place obliquely to the direction of forward travel, would have one aerofoil blade generating lift, whilst the retreating blade with its trailing edge facing into the relative air flow would generate very little (or possibly negative) lift.

One way to overcome this problem is to use an aerofoil with symmetrical cross-section (about the vertical centre plane), so that the leading and trailing edges are in effect interchangeable. However, such symmetry severely reduces the lift-generating capabilities and worsens the stall characteristics of an aerofoil, as its shape cannot be optimised for travel in a particular direction. Typically, the leading edge of any optimised lift-generating device should be relatively blunt but rounded to split the flow smoothly into two distinct streams of differing velocity above and below the aerofoil, at a range of angles of attack. The trailing edge, however, should be sharp to allow the streams to re-merge with minimal turbulence and separation. A symmetrical aerofoil necessitates a compromise between these two attributes.

The present invention seeks to provide a rotor blade that is aerodynamically more efficient at varying angles of attack and in reversed relative wind, to enable it to be used as a spinning rotor or to be fixed relative to an aircraft so that its blades serve as fixed wings.

### SUMMARY OF THE INVENTION

According to the present invention there is provided a rotor for a rotary wing aircraft, said rotor comprising a hub and a plurality of rotor blades, and each blade comprising:
an elongate, central body that is pivotally connected to the hub, to pivot about a pivot axis that extends longitudinally along the body, said body defining a longitudinal leading edge;
at least one flap that extends generally along the leading edge, said flap being pivotally attached to the body; and
a first leading camber adjustment mechanism that is configured to pivot the flap at the leading edge downwards relative to the body when the body is pivoted about its pivot axis relative to the hub, in a direction in which the body's leading edge is lifted relative to the body's pivot axis, i.e. with an increase in angle of attack of the body.

The terms “leading” and “trailing” are used herein for the sake of clarity, to refer to opposing edges of a rotor blade or part of a rotor blade. However, as will be clear from the preceding description and that below, the relative wind for some of the rotor blades may be reversed in use, in which case the “trailing” edge of the blade may become its leading edge. Accordingly, the words “leading” and “trailing” should not be viewed as strict references to the relevant edge's permanent function. Further, it is aeronautical convention to use the words “leading edge” and “trailing edge” to refer to the extreme edges of a wing, whether the extreme edges are formed by flaps or a fixed part. However, for the purposes of this description, the terms “leading edge” and “trailing edge” are used also when referring to the edges of the body of the rotor blade, even where these edges are not the extreme edges of the rotor blade.

The first leading camber adjustment mechanism of each rotor blade may be configured to hold the flap adjacent the leading edge against pivotal movement relative to the body, when the body is pivoted about the body's pivot axis relative to the hub, in a direction in which its leading edge is lowered relative to the body's pivot axis, i.e. with a decrease in angle of attack of the body, below a predetermined threshold.

The first leading camber adjustment mechanism of each rotor blade may include at least one inner arm that is pivotally attached to the body and that is fixedly attached to the flap adjacent the leading edge and the first leading camber adjustment mechanism may include an inner linkage extending between the inner arm and a formation that is fixed relative to the body's pivot axis. The inner linkage may be configured to transfer compressive loads, but to extend under tensile loads.

Each rotor blade may include a plurality of flaps at the leading edge and the flaps may include an inner flap, an outer flap and possibly more flaps in-between, the inner flap being immediately adjacent the leading edge and the outer flap being on the opposite side of the inner flap, the first leading camber adjustment mechanism being configured to pivot all the flaps relative to the body. Each rotor blade may further include a second leading camber adjustment mechanism that is configured to pivot the outer flap downwards relative to the inner flap when the inner flap is pivoted downwards relative to the body. Likewise, the rotor may include more leading camber adjustment mechanisms to pivot flaps between the inner and outer flap, downwards relative to the flap on its inside, when the angle of attack of the rotor blade increases.

The second leading camber adjustment mechanism may be configured to hold the outer flap against pivotal movement relative to the inner flap, when the body is pivoted about its pivot axis relative to the hub, in a direction in which the body's leading edge is lowered relative to the body's pivot axis, i.e. with a decrease in angle of attack of the body, below a predetermined threshold.

The second leading camber adjustment mechanism of each rotor blade may include at least one outer arm that is pivotally attached to the inner flap and that is fixedly attached to the outer flap and the second leading camber adjustment mechanism may include an outer linkage extending between the outer arm and a formation that is fixed relative to body's pivot axis.

The body of each rotor blade may define a trailing edge on a side of the blade, opposite from the leading edge, and each blade may include at least one flap that extends generally along the trailing edge and that is pivotally attached to the body. Each blade may include a first trailing camber adjustment mechanism that is configured to pivot the flap adjacent the trailing edge and the first trailing camber adjustment mechanism may be configured to pivot the flap adjacent the trailing edge downwards relative to the body when the body is pivoted about its pivot axis relative to the hub, in a direction in which the body's trailing edge is lifted relative to the body's pivot axis. (This would occur in use when the relative wind direction has been reversed, so that the “trailing” edge as described herein is in fact the leading edge, in use.)

The first trailing camber adjustment mechanism of each rotor blade may be configured to hold the flap adjacent the trailing edge against pivotal movement relative to the body, when the body is pivoted about its pivot axis relative to the hub, in a direction in which the body's trailing edge is lowered relative to the body's pivot axis, below a predetermined threshold.

The first trailing camber adjustment mechanism of each rotor blade may include at least one inner arm that is pivotally attached to the body and that is fixedly attached to the flap adjacent the trailing edge, said first trailing camber adjustment mechanism including an inner linkage extending between the inner arm and a formation that is fixed relative to the body's pivot axis. The inner linkage may be configured to transfer compressive loads, but to extend under tensile loads

Each rotor blade may include a plurality of said flaps adjacent the trailing edge, the flaps including at least an inner flap and an outer flap, or possibly more flaps in-between, the inner flap being immediately adjacent the trailing edge and the outer flap being on the opposite side of the inner flap, and the first trailing camber adjustment mechanism being configured to pivot both (or all of) these flaps relative to the body. Each rotor blade may further include a second trailing camber adjustment mechanism that is configured to pivot the outer flap downwards relative to the inner flap when the inner flap is pivoted downwards relative to the body.

The second trailing camber adjustment mechanism of each rotor blade may be configured to hold the outer flap against pivotal movement relative to the inner flap, when the body is pivoted about its pivot axis relative to the hub, in a direction in which the body's trailing edge is lowered relative to the body's pivot axis, below a predetermined threshold, i.e. with an increase in the body's angle of attack, with a relative wind direction from the leading edge to the trailing edge.

The second trailing camber adjustment mechanism may include one or more outer arm that is pivotally attached to the inner flap and that is fixedly attached to the outer flap, and the second trailing camber adjustment mechanism may include an outer linkage extending between the outer arm and a formation that is fixed relative to the body's pivot axis.

The body of each rotor blade may define an elongate inner cavity and each blade may include a spar that extends along the body's pivot axis, inside the cavity, the body being pivotable relative to the spar, about its pivot axis.

### BRIEF DESCRIPTION OF THE DRAWINGS

For a better understanding of the present invention, and to show how the same may be carried into effect, reference will now be made, by way of non-limiting example, to the accompanying drawings in which:

FIGS. 1A to 1E are diagrammatic sectional views showing the profiles of a rotor blade in accordance with the present invention during different operational conditions;

FIG. 2 is a diagrammatic sectional view of a leading half of the rotor blade shown in FIG. 1A; and

FIG. 3 is a diagrammatic sectional view of a leading half of the rotor blade shown in FIG. 1C.

### DETAILED DESCRIPTION

Referring to the drawings, a rotor blade of a rotor in accordance with the present invention is generally indicated by reference numeral 10.

Each rotor blade 10 is attached to a central hub (not shown) and a rigid cylindrical spar 12 extends radially from the hub and is fixed relative to the hub. The spar 12 is received in a longitudinal cavity inside the blade 12 and the blade is pivotal relative to the spar. The central axis of the spar 12 also serves as a pivot axis of the blade 10.

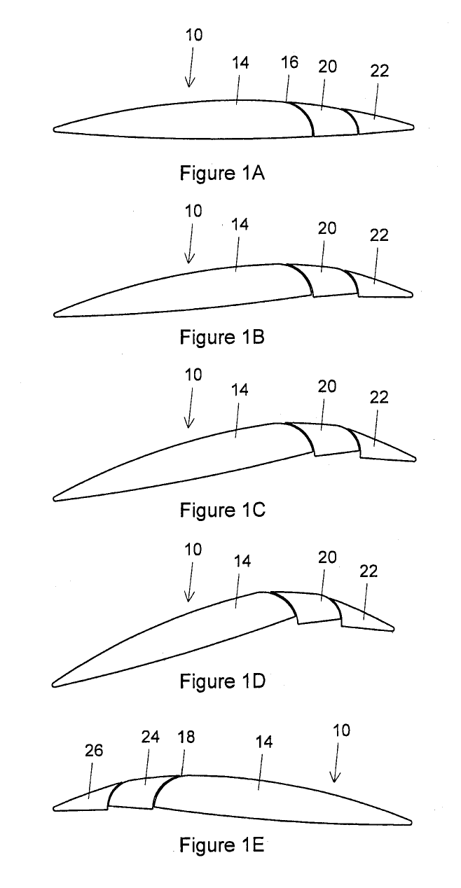

The blade 10 has an elongate, generally inflexible body 14 that extends longitudinally along its centre, with the spar 12 extending longitudinally along the centre of the body 14. The body 14 has a leading edge 16 and a trailing edge 18 on an opposing side. In the drawings, the leading edge 16 is shown on the right of the body 14 and the trailing edge 18 on its left. This would make sense if the relative wind (i.e. the movement of air relative to the blade 10) was from the right to the left in FIG. 1—as is the case in FIGS. 1A to 1D. However, in the case of FIG. 1E, the relative wind direction has been reversed, yet, for the sake of consistency, the edge on the left of the body 14 is still referred to as the “trailing edge” 18 and the edge on the right of the body is still referred to as the “leading edge” 16, even with reference to FIG. 1E.

The blade 10 has an inner leading flap 20 adjacent the leading edge 16, that is pivotally attached to the body 14 and an outer leading flap 22 on a side of the inner flap, opposite from the body, the outer leading flap being pivotally attached to the inner leading flap. Similarly, the blade 10 has an inner trailing flap 24, pivotally connected to the trailing edge 18 and an outer trailing flap 26, pivotally connected to the inner trailing flap. Each of the flaps 20-26 is a Fowler-style sliding flap that slides along a circumferential surface when it pivots.

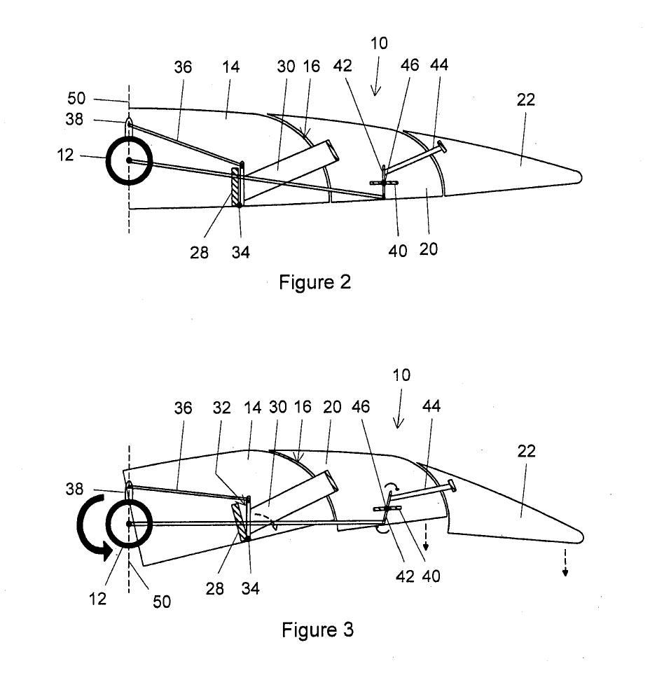

Referring in particular to FIGS. 2 and 3, the pivotal movement of the inner leading flap 20 relative to the body 14 is affected by a first leading camber adjustment mechanism that includes a minor spar 28 that is fixed relative to the body 14, an arm 30 that has a face 32 that can butt against the spar 28 and that can pivot relative to the body 14 about a pivot axis 34. The arm 30 is fixedly attached to the inner leading flap 20. A linkage 36 is pivotally connected to the arm 30 and to a protuberance 38 that is stationary relative to the hub and spar 12. The linkage 36 acts in a crank-like fashion to pivot the arm 30 about its pivot axis 34, during pivotal movement of the body 14 in which the trailing edge 16 is lifted above a neutral position as shown in FIG. 2, to an increased angle of attack as shown in FIG. 3. The linkage 36 is configured to transfer compressive forces during such pivotal movement without significant deformation and it maintains its length when the pivotal movement is reversed. However, if the body 14 is pivoted in the opposite direction beyond a predetermined threshold, e.g. if the body is pivoted from the neutral position shown in FIG. 2 in a direction in which its leading edge 16 is lowered, i.e. to give it a negative angle of attack, the linkage extends and it does not pivot the inner leading flap 20 relative to the body 14. One way in which this operation of the linkage 36 can be achieved is by locking the inner leading flap 20 against pivotal movement relative to the body 14 during negative angles of attack (the abutment between the face 32 and the spar 28 is an example of such locking) and allowing the linkage 36 to extend telescopically under tensile loads.

When the body 14 is pivoted about the spar 12 in a direction where its leading edge 16 is lifted above the neutral position shown in FIG. 2 (and FIG. 1A), i.e. when the angle of attack of the blade 10 is positive and is increased, the linkage 36 receives a compressive load and pushes the arm 30 so that it pivots about its axis 34 and the face 32 separates from the spar 28. The pivotal movement of the arm 30 about its axis 34 causes the inner leading flap 20 to pivot downwards relative to the body 14 and to slide Fowler-fashion relative to the curved leading edge 16, as can be seen in FIG. 3. If the body 14 is pivoted in the opposite direction from the position shown in FIG. 3 to the position shown in FIG. 2, i.e. if the positive angle of attack of the blade 10 were reduced, the reverse of the action described above would occur and the inner leading flap 20 would pivot upwards relative to the body 14.

However, if the body 14 were pivoted from the neutral position shown in FIG. 2 so that its leading edge 16 is tilted downwards, i.e. if the angle of attack of the blade 10 became negative, the spar 28 would pivot with the body 14 and would butt against the face 32, thus pressing the arm 30 (and inner leading flap 20) to pivot with the body 14. The pivotal movement of the arm 30 would exert a tensile load on the linkage 36, which would merely extend in length telescopically and the linkage 36 would not affect pivotal movement of the inner leading flap 20 relative to the body 14.

The pivotal movement of the outer leading flap 22 relative to the inner leading flap 20 is affected by a second leading camber adjustment mechanism which comprises a minor spar 40 on the inner leading flap 20, a swivel 42 that is pivotally connected to the spar 40 at pivot axis 46, an arm 44 that is fixedly connected to the outer leading flap 22 and to one end of the swivel, and a linkage 48 that is pivotally connected to the other end of the swivel and to the spar 12 on the pivot axis of the body.

When the inner leading flap 20 pivots downwards relative to the body 14, the pivotal movement causes an increase in the distance between the spar 12 and axis 46, so that the linkage 48 pulls the swivel 42 in crank fashion and pivots it relative to the axis 46 (in a clockwise direction as shown on FIG. 3) and the movement of the swivel causes the arm 44 and the outer leading flap 22 (which are fixedly attached to the swivel) to pivot about the axis 46 so that the outer leading flap 22 pivots downwards relative to the inner leading flap in Fowler fashion. In other embodiments of the invention, the blade 10 may be provided with more leading flaps, each with an associated camber adjustment mechanism that it configured to pivot it downwards as the angle of attack of the blade is increased.

In the illustrated embodiment, the inner leading flap 20 remains stationary relative to the body 14 when the angle of attack of the blade 10 becomes negative. Accordingly, there is no pivotal movement between the body 14 and the inner leading flap 20 to trigger movement in the second camber adjustment mechanism. The ability of the linkage 48 to extend under tensile loads is thus not required as in its counterpart linkage 36 in the first camber adjustment mechanism.

The first and second camber adjustment mechanisms for the inner and outer leading flaps 20,22 are mirrored about a vertical plane of symmetry 50, to affect similar pivotal movement of the inner and outer trailing flaps 24,26. In fact, the entire blade 10 is symmetrical about the plane 50.

From the structure of the blade 10 described above with reference to FIGS. 2 and 3, it is clear that in the case of a positive angle of attack of the body 14, the leading flaps 20,22 would pivot down, thus increasing the blade's camber and the trailing flaps 24,26 would remain stationary relative to the body 14. If the blade 10 were pivoted in the opposite direction, the leading flaps 20,22 would remain stationary relative to the body 14 and the trailing flaps 24,26 would pivot downwards to increase camber. This pivotal motion of the body 14 “in the opposite direction” has been described with reference to FIGS. 2 and 3 as a negative angle of attack, but it would actually only occur in practice when the relative wind direction has been reversed and it would amount in practice to a positive angle of attack relative to the reversed relative wind.

In the illustrated embodiment of the invention, the leading flaps 20,22 are kept stationary relative to the body 14 when the body is pivoted to give it a negative pitch (i.e. when the body 14 is pivoted to lower its leading edge 16 beyond the neutral position). However, in other embodiments of the invention, the leading flaps 20,22 may be allowed to pivot upwards relative to the body 14 by operation of the first and second camber adjustment mechanisms, as described above, giving the blade 10 an S-shaped profile. Further, it may be possible for the flaps 20,22 to be pivoted relative to the body 14 when it has a pitch above a predetermined threshold and to be held stationary relative to the body when it has a pitch is below the threshold (i.e. the threshold need not be at zero pitch, as in the case of the illustrated embodiment). The design of the camber adjustment mechanisms may vary to provide the aerodynamic characteristics that best suit a particular application.

The mechanical camber adjustment mechanism described above can be replaced with other systems such as other mechanical devices, electro-mechanical devices, hydraulic devices, or the like.

When the rotor in accordance with the present invention is used in a helicopter, it can be used in a neutral or feathered condition as shown in FIG. 1A (and FIG. 2) when no lift is required, e.g. when the helicopter is on land. In this position, the blade 10 has a zero angle of attack and the leading flaps 20,22 and trailing flaps 24,26 have not been pivoted relative to the body 14.

As the pitch or angle of attack of the blade 10 increases in use, as shown in FIGS. 1B to 1C, while the rotor is rotating and the relative wind is in the direction from right to left in the drawings, the leading flaps 20,22 pivot downwards relative to the body 14 to increase camber, while the trailing flaps 24,26 remain stationary relative to the body. The increase in camber in the leading part of the blade 10 gives the blade a cambered profile that is significantly more efficient in providing lift, than a blade with a fixed profile would have been.

The rotor in accordance with the present invention is also intended to be used in a hybrid aircraft where the rotor can be stopped in flight so that its blades 10 can act as fixed wings. For purposes of description, reference is made to a blade 10 that was advancing relative to the aircraft when it was stopped to act as a fixed wing, as an “advancing blade” and reference will be made to a blade on an opposing side of the rotor that was retreating relative to the aircraft before it was stopped, as a “retreating blade” (even though both blades are stationary relative to the aircraft in the fixed wing mode).

In the fixed wing mode, the angle of attack of the advancing blade 10 will preferably be positive, e.g. it can be as shown in FIG. 1B, with a moderate increase in camber resulting from a moderate lowering of the leading flaps 20,22 as described above. For the retreating blade 10, the relative wind direction has been reversed when the aircraft converted from the rotary wing mode to the fixed wing mode and the angle of attack needs to be “reversed”, so that is negative with the same absolute value as that of the advancing blade, although the angle of attack of both blades will in fact be positive in relation to their respective relative wind directions. When the retreating blade 10 is pivoted to its “negative” angle of attack, the leading flaps 20,22 remain stationary relative to the body 14, while the trailing flaps 24,26 pivot downwards as described above, to provide a cambered, optimised profile as shown in FIG. 1E that is the mirror image of that of the advancing blade shown in FIG. 1B.

This system has a number of advantages in addition to the above-mentioned reversible adaptation of the rotor blades between helicopter and fixed-wing modes. Significantly, the blades would be adjustable for the desired aerodynamic characteristics depending on the flight condition. For example, large pitch and camber would be selected for maximum lift at full collective in helicopter mode, whilst minimal pitch and camber chosen for efficient high-speed cruise in fixed-wing mode.

In addition, the increase in camber with blade pitch angle improves the stall characteristics of the aerofoil, delaying flow separation by keeping the leading edge approximately in line with the direction of motion, whilst generating increased lift. Moreover, this increase in generated lift, due to the enhanced camber, means that for any given flight circumstance, the overall aerofoil pitch angle can be reduced, thus reducing drag and improving efficiency. Aerofoil flow characteristics are further improved by the use of the sliding Fowler-style flaps, which allow a more streamlined curvature profile to the upper surface of the aerofoil than alternative flap arrangements would permit, amongst other things reducing the likelihood of flow separation.

The reversing aerofoil diminishes many of the problems inherent with the development of a convertible high-speed vertical take-off and landing (VTOL) aircraft. Operating weight is extensively reduced by the use of only one set of primary lifting surfaces for both rotor and fixed-wing mode, whilst the shape variation capabilities eliminate compromises in aerodynamic performance and efficiency regardless of the flight condition.

The present invention was motivated by the exceptional requirements of an aircraft that can convert in flight between a rotary wing (helicopter) mode of operation and a fixed wing mode, but many aspects of the invention can also be used in a wide array of aerodynamic applications, e.g. in conventional helicopters.

1. A rotor for a rotary wing aircraft, said rotor comprising a hub and a plurality of rotor blades, and each blade comprising:
an elongate, central body that is pivotally connected to the hub, to pivot about a pivot axis that extends longitudinally along the body, said body defining a longitudinal leading edge; and
at least one flap that extends generally along the leading edge, said flap being pivotally attached to the body;
said rotor blade including a first leading camber adjustment mechanism that is configured to pivot the flap at the leading edge downwards relative to the body when the body is pivoted about its pivot axis relative to the hub, in a direction in which the body's leading edge is lifted relative to the body's pivot axis.

2. A rotor as claimed in claim 1, wherein the first leading camber adjustment mechanism of each rotor blade is configured to hold the flap adjacent the leading edge against pivotal movement relative to the body, when the body is pivoted about its pivot axis relative to the hub, in a direction in which the body's leading edge is lowered relative to the body's pivot axis, below a predetermined threshold.

3. A rotor as claimed in claim 1, wherein the first leading camber adjustment mechanism of each rotor blade includes at least one inner arm that is pivotally attached to the body and that is fixedly attached to the flap adjacent the leading edge, said first leading camber adjustment mechanism including an inner linkage extending between the inner arm and a formation that is fixed relative to the body's pivot axis.

4. A rotor as claimed in claim 3, wherein the inner linkage of the first leading camber adjustment mechanism of each rotor blade is configured to transfer compressive loads, but to extend under tensile loads.

5. A rotor as claimed in claim 1, wherein each rotor blade includes a plurality of said flaps at the leading edge, said flaps including at least an inner flap and an outer flap, the inner flap being immediately adjacent the leading edge and the outer flap being on the opposite side of the inner flap, the first leading camber adjustment mechanism being configured to pivot both said flaps relative to the body, wherein each rotor blade further includes a second leading camber adjustment mechanism that is configured to pivot said outer flap downwards relative to said inner flap when the inner flap is pivoted downwards relative to the body.

6. A rotor as claimed in claim 5, wherein the second leading camber adjustment mechanism of each rotor blade is configured to hold the outer flap against pivotal movement relative to the inner flap, when the body is pivoted about its pivot axis, relative to the hub, in a direction in which the body's leading edge is lowered relative to the body's pivot axis below a predetermined threshold.

7. A rotor as claimed in claim 5, wherein the second leading camber adjustment mechanism of each rotor blade includes at least one outer arm that is pivotally attached to said inner flap and that is fixedly attached to said outer flap, said second leading camber adjustment mechanism including an outer linkage extending between the outer arm and a formation that is fixed relative to body's pivot axis.

8. A rotor as claimed in claim 1, wherein the body of each rotor blade defines a trailing edge on a side of the blade, opposite from the leading edge, and each blade includes at least one flap that extends generally along the trailing edge and being pivotally attached to the body, each blade including a first trailing camber adjustment mechanism that is configured to pivot the flap adjacent the trailing edge, said first trailing camber adjustment mechanism being configured to pivot the flap adjacent the trailing edge downwards relative to the body when the body is pivoted about its pivot axis, relative to the hub, in a direction in which the body's trailing edge is lifted relative to the body's pivot axis.

9. A rotor as claimed in claim 8, wherein the first trailing camber adjustment mechanism of each rotor blade is configured to hold the flap adjacent the trailing edge against pivotal movement relative to the body, when the body is pivoted about its pivot axis relative to the hub, in a direction in which the body's trailing edge is lowered relative to the body's pivot axis, below a predetermined threshold.

10. A rotor as claimed in claim 8, wherein the first trailing camber adjustment mechanism of each rotor blade includes at least one inner arm that is pivotally attached to the body and that is fixedly attached to the flap adjacent the trailing edge, said first trailing camber adjustment mechanism including an inner linkage extending between the inner arm and a formation that is fixed relative to the body's pivot axis.

11. A rotor as claimed in claim 10, wherein the inner linkage of the first trailing camber adjustment mechanism of each rotor blade is configured to transfer compressive loads, but to extend under tensile loads

12. A rotor as claimed in claim 8, wherein each rotor blade includes a plurality of said flaps adjacent the trailing edge, said flaps including at least an inner flap and an outer flap, the inner flap being immediately adjacent the trailing edge and the outer flap being on the opposite side of the inner flap, the first trailing camber adjustment mechanism being configured to pivot both said flaps relative to the body, wherein each rotor blade further includes a second trailing camber adjustment mechanism that is configured to pivot said outer flap downwards relative to said inner flap when the inner flap is pivoted downwards relative to the body.

13. A rotor as claimed in claim 12, wherein the second trailing camber adjustment mechanism of each rotor blade is configured to hold said outer flap against pivotal movement relative to said inner flap, when the body is pivoted about its pivot axis relative to the hub, in a direction in which the body's trailing edge is lowered relative to the body's pivot axis, below a predetermined threshold.

14. A rotor as claimed in claim 12, wherein the second trailing camber adjustment mechanism of each rotor blade includes at least one outer arm that is pivotally attached to said inner flap and that is fixedly attached to said outer flap, said second trailing camber adjustment mechanism including an outer linkage extending between the outer arm and a formation that is fixed relative to the body's pivot axis.

15. A rotor as claimed claim 1, wherein the body of each rotor blade defines an elongate inner cavity and each blade includes a spar that extends along the body's pivot axis, inside the cavity, the body being pivotable relative to the spar, about its pivot axis.
